(19) United States
(12) Patent Application Publication
(10) Pub. No.: US 2025/0106876 A1
(43) Pub. Date: Mar. 27, 2025

(54) RADIO TERMINAL AND METHOD THEREFOR

(71) Applicant: NEC Corporation, Minato-ku, Tokyo (JP)

(72) Inventor: Satoaki HAYASHI, Tokyo (JP)

(73) Assignee: NEC Corporation, Minato-ku, Tokyo (JP)

(21) Appl. No.: 18/290,850

(22) PCT Filed: Jun. 30, 2022
(86) PCT No.: PCT/JP2022/026159

§ 371 Date: Jan. 22, 2024

(30) Foreign Application Priority Data
Jul. 30, 2021 (JP) 2021-125876

(51) Int. Cl. H04W 72/40; H04W 24/10; H04W 72/02

(52) U.S. Cl. CPC H04W 72/40; H04W 24/10; H04W 72/02

(57) ABSTRACT

A first radio terminal (1A) transmits to a second radio terminal (1B) inter-terminal coordination information generated based on a result of its own sensing. The inter-terminal coordination information indicates a first set of preferred resources for sidelink transmission by the second radio terminal (1B) or a second set of non-preferred resources for sidelink transmission by the second radio terminal (1B). The inter-terminal coordination information further indicates a trust level of each resource in the first or second set. This allows, for example, a second radio terminal receiving inter-terminal coordination information to distinguish between the trust or importance levels of multiple preferred or non-preferred resources.

### TECHNICAL FIELD

The present disclosure relates to direct communication between radio terminals (device-to-device (D2D) communication), in particular to coordination between radio terminals for a resource selection mode in which a radio terminal autonomously selects resources for transmission from a resource pool.

### BACKGROUND ART

The mode in which a radio terminal communicates directly with another radio terminal, without the need for an infrastructure network such as a base station, is commonly referred to as device-to-device (D2D) communication. D2D communications can be integrated with or assisted by a cellular network. Proximity-based services (ProSe), specified in the Third Generation Partnership Project (3GPP (registered trademark)) Release 12 and beyond, provide a system architecture for D2D communications assisted by a cellular network. In addition, cellular Vehicle-to-Everything (V2X) services, specified in 3GPP Release 14 and beyond, refer to ProSe and use D2D communications between radio terminals. D2D communications assisted by a cellular network can also be used for other applications and services (e.g., public safety applications) in addition to V2X services.

The interface between 3GPP radio terminals (i.e., User Equipments (UEs)) used in the control and user planes for D2D communications is called the PC5 interface (or reference point). The PC5 interface can be based on Evolved Universal Terrestrial Radio Access (E-UTRA) sidelink capability and can also be based on 5G New Radio (NR) sidelink capability. D2D communications over the PC5 interface are referred to as sidelink communications. D2D communications (or sidelink communications) over the E-UTRA-PC5 (or Long Term Evolution (LTE) based PC5) interface are connectionless, i.e., broadcast mode at the Access Stratum (AS) layer. In contrast, user-plane communications over the NR PC5 interface support unicast mode, groupcast mode and broadcast mode at the AS layer.

To support various V2X and public safety use cases, the 3GPP RAN Working Group is currently developing a standard specification for the Release 17 NR sidelink enhancement. One of the objectives of this study item is to support inter-UE coordination to enhance NR sidelink resource allocation mode 2 (e.g., see Non-Patent Literature 1-5). In NR sidelink resource allocation mode 2, UEs autonomously select radio resources (i.e., one or more sub-channels) for sidelink transmission from a resource pool. In this case, the UEs can operate out of network coverage. The resource pool is (pre) configured by the network (i.e., gNB or eNB) when the UEs are in network coverage. Inter-UE coordination allows a UE to assist another UE in the mode 2 resource selection.

There are two types of inter-UE coordination: Scheme 1 and Scheme 2. In Scheme 1, the inter-UE coordination information sent from UE-A to UE-B indicates one or both of a set of preferred resources and a set of non-preferred resources for transmission by the UE-B. For example, in Scheme 1, the UE-B may (re) select resources for sidelink transmission by the UE-B based at least on the inter-UE coordination information from the UE-A. More specifically, the UE-B may select resources for sidelink transmission from the common part (i.e., the intersection) between the set of candidate resources obtained by the UE-B through its own sensing and the set of preferred resources indicated in the inter-UE coordination information (see Non-Patent Literature 1). Alternatively, the UE-B may exclude the set of non-preferred resources indicated in the inter-UE coordination information from the set of candidate resources obtained by the UE-B through its own sensing, and perform resource selection from the final set of candidate resources (see Non-Patent Literature 1).

On the other hand, in Scheme 2, the inter-UE coordination information sent by the UE-A to the UE-B indicates the presence of an expected or potential resource conflict on the resource(s) indicated (or reserved) by Sidelink Control Information (SCI) of the UE-B. Additionally or alternatively, in Scheme 2, the inter-UE coordination information sent by the UE-A to the UE-B indicates the existence (or presence) of a resource conflict detected by the UE-A on the resource(s) indicated (or reserved) by the SCI of the UE-B. For example, in Scheme 2, the UE-B may determine resources to be reselected or the need for retransmission based at least on the inter-UE coordination information from the UE-A.

In these two types of coordination between UEs, the UE-A may be referred to as an assisting UE, a coordinator UE or a coordination requested UE, while the UE-B may be referred to as an assisted UE, a coordination request UE, a coordination requesting UE or a transmitting UE (Tx-UE).

The transmission of the inter-UE coordination information from the UE-A to the UE-B may be based on an explicit request from the UE-B or on the detection of a given (or specific) event by the UE-A. The coordination information may include additional information such as the Reference Signal Received Power (RSRP) of the transmission associated with the SCI of another UE and the priority contained in that SCI (see Non-Patent Literature 1 and 2). The Scheme 1 inter-UE coordination information may indicate the cause of non-preferred resources, e.g., due to a half-duplex problem or due to a hidden-node problem (see Non-Patent Literature 1 and 2). The Scheme 2 inter-UE coordination information may include an indication of whether a resource conflict is due to half-duplex or resource collision (see, e.g., Non-Patent Literature 1 and 3-5).

The container for carrying the inter-UE coordination information may be physical layer signaling, layer 2 signaling, or PC5 Radio Resource Control (RRC) signaling. Physical layer signaling may be, for example, 1st-stage SCI (e.g., SCI format 1-A), 2nd-stage SCI (e.g., SCI format 2-A or 2-B), or a format analogous to the Physical Sidelink Feedback Channel (PSFCH) format. Layer 2 signaling may be a Medium Access Control (MAC) Control Element (CE).

### CITATION LIST

### Non Patent Literature

[Non-Patent Literature 1] LG Electronics, “Feature lead summary for AI 8.11.1.2 Inter-UE coordination for Mode 2 enhancements”, R1-2106338, 3GPP TSG RAN WG1 Meeting #105-e, May 10th-27th, 2021
[Non-Patent Literature 2] Apple, “On Inter-UE Coordination”, R1-2105127, 3GPP TSG RAN WG1 Meeting #105-e, May 10th-27th, 2021
[Non-Patent Literature 3] Intel Corporation, “Inter-UE Coordination Schemes for Sidelink Communication”, R1-2104927, 3GPP TSG RAN WG1 Meeting #105-e, May 10th-27th, 2021
[Non-Patent Literature 4] LG Electronics, “Discussion on inter-UE coordination for Mode 2 enhancements”, R1-2105205, 3GPP TSG RAN WG1 Meeting #105-e, May 10th-27th, 2021
[Non-Patent Literature 5] InterDigital, Inc., “On inter-UE coordination for Mode 2 enhancement”, R1-2105675, 3GPP TSG RAN WG1 Meeting #105-e, May 10th-27th, 2021

### SUMMARY OF INVENTION

### Technical Problem

Currently, it is not clear how the inter-UE coordination information for the mode 2 resource selection is determined by the UE-A (i.e., assisting UE) and what the content of the inter-UE coordination information is. The inventor has investigated these issues and found several problems.

One of these problems relates to the content of the inter-UE coordination information in Scheme 1. As mentioned above, in Scheme 1, the inter-UE coordination information sent by the UE-A to the UE-B indicates a set of preferred resources and/or a set of non-preferred resources for transmission by the UE-B. In an example, the UE-B may select resources for sidelink transmission from the common part (i.e., the intersection) between the set of candidate resources obtained by the UE-B through its own sensing and the set of preferred resources indicated in the inter-UE coordination information (see Non-Patent Literature 1). Alternatively, the UE-B may exclude the set of non-preferred resources indicated in the inter-UE coordination information from the set of candidate resources obtained by the UE-B through its own sensing, and perform resource selection from the final set of candidate resources (see Non-Patent Literature 1). However, multiple preferred or non-preferred resources indicated by the UE-A may have different trust or importance to each other. It may be desirable for the UE-B to be able to distinguish between the trust or importance levels of multiple preferred or non-preferred resources and determine which preferred or non-preferred resources should be considered in its own resource selection.

Another one of these problems relates to the determination of inter-UE coordination information by the UE-A in the inter-UE coordination schemes 1 and 2. Another objective of the Release 17 NR sidelink enhancement is to support discontinuous reception (DRX) on the sidelink. If the UE-A is configured with DRX, the UE-A may not perform any receive processing during the DRX off duration within the sensing window. This could result in a significant increase of slots in the sensing window where the UE-A does not receive SCIs from other UEs. If the preferred or non-preferred resources for the inter-UE coordination scheme 1 are determined based on hypothetical SCIs that could have been received in slots within the DRX OFF duration, this may result in a significant decrease of the preferred resources or a significant increase of the non-preferred resources. Similarly, if the existence of expected or potential resource conflicts for inter-UE coordination scheme 2 is determined based on hypothetical SCIs that could have been received in slots within the DRX OFF duration, this may result in a significant increase in resource conflicts.

One of the objects to be accomplished by example embodiments disclosed herein is to provide apparatuses, methods, and programs that contribute to solving at least one of a plurality of problems, including the above-described problems related to inter-terminal coordination for resource selection for D2D transmission. It should be noted that this object is merely one of the objects to be achieved by the example embodiments disclosed herein. Other objects or problems and novel features will be made apparent from the following description and the accompanying drawings.

### Solution to Problem

In a first aspect, a first radio terminal includes at least one radio transceiver and at least one processor coupled to the at least one radio transceiver. The at least one processor is configured to perform sensing to detect resources reserved for sidelink transmission by one or more other radio terminals, and to transmit to the second radio terminal inter-terminal coordination information generated based on a result of the sensing. The inter-terminal coordination information indicates a first set of preferred resources for sidelink transmission by the second radio terminal or a second set of non-preferred resources for sidelink transmission by the second radio terminal. The inter-terminal coordination information indicates a trust level of each resource in the first or second set.

In a second aspect, a method performed by a first radio terminal includes: performing sensing to detect resources reserved for sidelink transmission by one or more other radio terminals; and transmitting to the second radio terminal inter-terminal coordination information generated based on a result of the sensing. The inter-terminal coordination information indicates a first set of preferred resources for sidelink transmission by the second radio terminal or a second set of non-preferred resources for sidelink transmission by the second radio terminal. The inter-terminal coordination information indicates a trust level of each resource in the first or second set.

In a third aspect, a second radio terminal includes at least one radio transceiver and at least one processor coupled to the at least one radio transceiver. The at least one processor is configured to receive, from a first radio terminal, inter-terminal coordination information generated based on a result of sensing by the first radio terminal. The inter-terminal coordination information indicates a first set of preferred resources for sidelink transmission by the second radio terminal or a second set of non-preferred resources for sidelink transmission by the second radio terminal. The inter-terminal coordination information indicates a trust level of each resource in the first or second set.

In a fourth aspect, a method performed by a second radio terminal includes receiving, from a first radio terminal, inter-terminal coordination information generated based on a result of sensing by the first radio terminal. The inter-terminal coordination information indicates a first set of preferred resources for sidelink transmission by the second radio terminal or a second set of non-preferred resources for sidelink transmission by the second radio terminal. The inter-terminal coordination information indicates a trust level of each resource in the first or second set.

In a fifth aspect, a first radio terminal includes at least one radio transceiver and at least one processor coupled to the at least one radio transceiver. The at least one processor is configured to perform sensing to detect resources reserved for sidelink transmission by one or more other radio terminals. The at least one processor is configured to determine a first set of preferred resources for sidelink transmission by a second radio terminal or a second set of non-preferred resources for sidelink transmission by the second radio terminal, based on sidelink control information actually received from any other radio terminal during the sensing, without considering hypothetical sidelink control information that could have been received in a slot that the first radio terminal was unable to monitor during the sensing. Further, the at least one processor is configured to transmit, to the second radio terminal, inter-terminal coordination information indicating the first or second set.

In a sixth aspect, a method performed by a first radio terminal includes:
(a) performing sensing to detect resources reserved for sidelink transmission by one or more other radio terminals;
(b) determining a first set of preferred resources for sidelink transmission by a second radio terminal or a second set of non-preferred resources for sidelink transmission by the second radio terminal, based on sidelink control information actually received from any other radio terminal during the sensing, without considering hypothetical sidelink control information that could have been received in a slot that the first radio terminal was unable to monitor during the sensing; and
(c) transmitting, to the second radio terminal, inter-terminal coordination information indicating the first or second set.

In a seventh aspect, a first radio terminal includes at least one radio transceiver and at least one processor coupled to the at least one radio transceiver. The at least one processor is configured to perform sensing to detect resources reserved for sidelink transmission by one or more other radio terminals. The at least one processor is configured to determine existence of an expected or potential resource conflict at a resource indicated by sidelink control information of a second radio terminal, based on sidelink control information actually received from any other radio terminal during the sensing, without considering hypothetical sidelink control information that could have been received in a slot that the first radio terminal was unable to monitor during the sensing. Further, the at least one processor is configured to transmit, to the second radio terminal, inter-terminal coordination information indicating the existence of the resource conflict.

In an eighth aspect, a method performed by a first radio terminal includes:
(a) performing sensing to detect resources reserved for sidelink transmission by one or more other radio terminals;
(b) determining existence of an expected or potential resource conflict at a resource indicated by sidelink control information of a second radio terminal, based on sidelink control information actually received from any other radio terminal during the sensing, without considering hypothetical sidelink control information that could have been received in a slot that the first radio terminal was unable to monitor during the sensing; and
(c) transmitting, to the second radio terminal, inter-terminal coordination information indicating the existence of the resource conflict.

A ninth aspect is directed to a program. The program includes a set of instructions (software codes) that, when loaded into a computer, cause the computer to perform the method according to the second, fourth, sixth, or eighth aspect described above.

### Advantageous Effects of Invention

According to the aspects described above, it is possible to provide apparatuses, methods and programs that contribute to solving at least one of a plurality of problems related to inter-terminal coordination for resource selection for D2D transmission.

### BRIEF DESCRIPTION OF DRAWINGS

FIG. 1 shows an example configuration of a radio communication system according to an example embodiment;

FIG. 2 shows an example of signaling between UEs according to an example embodiment;

FIG. 3 is a flowchart showing an example of operation of a UE according to an example embodiment;

FIG. 4 is a flowchart showing an example of operation of a UE according to an example embodiment;

FIG. 5 is a diagram illustrating an example of the determination of preferred or non-preferred resources by a UE according to an example embodiment;

FIG. 6 shows an example of operation of a UE according to an example embodiment;

FIG. 7 is a flowchart showing an example of operation of a UE according to an example embodiment;

FIG. 8 is a flowchart showing an example of operation of a UE according to an example embodiment;

FIG. 9 is a flowchart showing an example of operation of a UE according to an example embodiment;

FIG. 10 is a flowchart showing an example of operation of a UE according to an example embodiment; and

FIG. 11 is a block diagram showing an example configuration of a UE according to an example embodiment.

### EXAMPLE EMBODIMENT

Specific example embodiments will be described hereinafter in detail with reference to the drawings. The same or corresponding elements are denoted by the same symbols throughout the drawings, and duplicated explanations are omitted as necessary for the sake of clarity.

Each of the example embodiments described below may be used individually, or two or more of the example embodiments may be appropriately combined with one another. These example embodiments include novel features different from each other. Accordingly, these example embodiments contribute to attaining objects or solving problems different from one another and contribute to obtaining advantages different from one another.

The example embodiments presented below are primarily described for the 3GPP 5th generation mobile communication system (5G system). However, these example embodiments can be applied to other radio communication systems that support D2D communication technology similar to 3GPP NR sidelink communication.

As used in this specification, “if” can be interpreted to mean “when”, “at or around the time”, “after”, “upon”, “in response to determining”, “in accordance with a determination”, or “in response to detecting”, depending on the context.

### First Example Embodiment

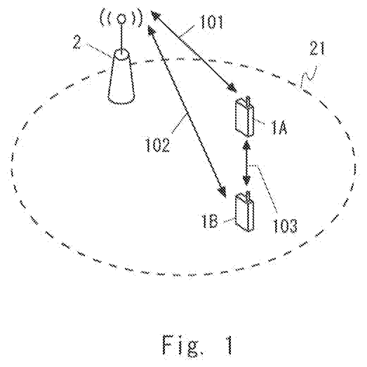

FIG. 1 shows an example configuration of a radio communication system according to a plurality of example embodiments, including the present example embodiment. A Radio Access Network (RAN) node (e.g., gNB) 2 manages a cell 21 and is capable of performing cellular communications (101 and 102) with a plurality of radio terminals (UEs) 1, including UEs 1A and UE 1B, using a cellular communication technology (i.e., NR Radio Access Technology). The example in FIG. 1 shows a situation where the UEs 1A and 1B are located in the same cell 21 for ease of explanation, but such an arrangement is only an example. For example, the UE 1A may be located in one of two adjacent cells managed by different RAN nodes 2, and the UE 1B may be located in the other cell. Alternatively, at least one of the UE 1A and the UE 1B may be located outside the coverage of one or more RAN nodes 2 (i.e., partial coverage, out-of-coverage).

Each of the UE 1A and the UE 1B has at least one radio transceiver and is configured to perform cellular communication (101 or 102) with the RAN node 2 and to perform D2D communication (i.e., sidelink communication) on a direct inter-UE interface (i.e., NR PC5 interface or NR sidelink) 103. The sidelink communication includes unicast mode communication (sidelink unicast) and may further include one or both of groupcast mode communication and broadcast mode communication.

As already described, D2D communications can be integrated with or assisted by a cellular network. D2D communications assisted by a cellular network can be used, for example, for V2X services and other applications and services (e.g., public safety applications).

The interface between the UE 1A and the UE 1B used in the control and user planes for D2D communications is called the PC5 interface (or reference point). The PC5 interface can be based on E-UTRA sidelink capability and can also be based on 5G NR sidelink capability. D2D communications over the PC5 interface are referred to as sidelink communications. D2D communications (or sidelink communications) over the E-UTRA-PC5 (or LTE based PC5) interface are connectionless, i.e., broadcast mode at the AS layer. In contrast, user-plane communications over the NR PC5 interface support unicast mode, groupcast mode and broadcast mode at the AS layer.

In NR sidelink resource allocation mode 2, the UE 1A and the UE 1B autonomously select radio resources (i.e., one or more sub-channels) for sidelink transmission from a resource pool. In this case, the UE 1A and the UE 1B can operate out of network coverage. The resource pool is (pre) configured by the network (i.e., gNB or eNB) when the UE 1A and the UE 1B are in network coverage.

An example of inter-UE coordination to assist resource selection by the UE 1B for NR sidelink resource allocation mode 2 is described below. In the following, NR sidelink resource allocation mode 2 is sometimes referred to as mode 2 resource selection. Inter-UE coordination allows the UE 1A to assist the UE 1B in the mode 2 resource selection. In the mode 2 resource selection, the UE 1B autonomously selects radio resources for sidelink transmission from a resource pool. Here, the radio resources are one or more sub-channels. A sub-channel contains a plurality of resource blocks in a slot. The resource pool is (pre) configured by the network (e.g., RAN node) when the UE 1B (and the UE 1A) are in network coverage.

In this embodiment, the UE 1A and the UE 1B support at least the inter-UE coordination scheme 1. The UE 1A and the UE 1B may support the inter-UE coordination scheme 2.

In the inter-UE coordination scheme 1, the inter-UE coordination information sent by the UE 1A to the UE 1B indicates one or both of a set of preferred resources and a set of non-preferred resources for transmission by the UE 1B. For example, in Scheme 1, the UE 1B may (re) select resources for sidelink transmission by the UE 1B based at least on the inter-UE coordination information from the UE 1A. More specifically, the UE 1B may select resources for sidelink transmission from the common part (i.e., the intersection) between the set of candidate resources obtained by the UE 1B through its own sensing and the set of preferred resources indicated in the inter-UE coordination information. Alternatively, the UE 1B may exclude the set of non-preferred resources indicated in the inter-UE coordination information from the set of candidate resources obtained by the UE 1B through its own sensing, and perform resource selection from the final set of candidate resources.

For ease of explanation, hereafter the UE 1A may be referred to as an assisting UE and the UE 1B as an assisted UE. The UE 1A may be referred to as a coordinator UE or a coordination requested UE, while the UE 1B may be referred to as a coordination request UE, a coordination requesting UE, or a transmitting UE (Tx-UE). Sidelink communication can be used for V2X services. In this case, the UE 1A (or the assisting UE) may be a Road Side Unit (RSU) (e.g., UE type RSU) and the UE 1B (or the assisted UE) may be a vehicle UE (or vehicle mounted UE) or a pedestrian UE (e.g., a smartphone).

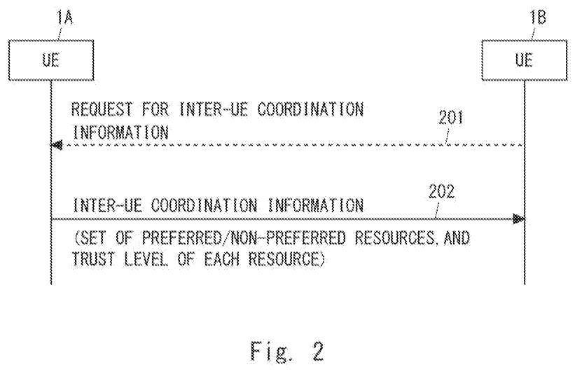

FIG. 2 shows an example of signaling between the assisting UE 1A and the assisted UE 1B with respect to the inter-UE coordination scheme 1. In step 202, the UE 1A sends inter-UE coordination information to the UE 1B. The container used to carry the inter-UE coordination information may be physical layer signaling, layer 2 signaling, or PC5 RRC signaling. The physical layer signaling may be, for example, 1st-stage SCI (e.g., SCI format 1-A), 2nd-stage SCI (e.g., SCI format 2-A, 2-B), or a PSFCH-like format. The layer 2 signaling may be a MAC CE.

The transmission of the inter-UE coordination information from the UE 1A to the UE 1B (step 202) may be based on the detection of a predetermined (or certain) event by the UE 1A. Alternatively, by way of example, but not by way of limitation, the UE 1A may transmit the inter-UE coordination information to the UE 1B in response to a request or trigger (step 201) from the UE 1B. The request from the UE 1B may be transmitted in a PSFCH-like format, SCI, MAC CE, or PC5 RRC signaling. The request from the UE 1B may specify parameters related to resource selection by the UE 1B. These parameters may include a parameter indicating a time interval for defining a plurality of candidate resources from which the UE 1A will select preferred or non-preferred resources. This time interval may be referred to as a selection window. In particular, these parameters may include the parameters required for sensing for the mode 2 resource selection in the current Release 16. More specifically, these parameters may include one or any combination of a resource pool used by the UE 1B, a priority, a remaining PDB, the number of sub-channels used for PSSCH/PSCCH transmission, and a resource reservation interval. Additionally or alternatively, the request from the UE 1B may specify the type of inter-UE coordination information requested (e.g., a set of preferred or a set of non-preferred resources, or scheme 1 or scheme 2).

The inter-UE coordination information in step 202 indicates a set of preferred resources for sidelink transmission by the UE 1B or a set of non-preferred resources for sidelink transmission by the UE 1B. In the following, the set of preferred resources is referred to as the first set and the set of non-preferred resources is referred to as the second set. The inter-UE coordination information also specifies the trust level (or importance level) of each resource in the first or second set. The number of possible values for the trust or importance level can be two, three, or more. In an example, the possible values of the trust level may be “trusted” and “untrusted”. The possible values of the importance level may be “important” and “unimportant”. The trust or importance level may be referred to, for example, as a priority level or a priority. The possible values of the priority level (or priority) may be “high (priority)” and “low (priority)”. For example, if the number of trust levels is four, then the trust levels can be “00”, “01”, “10”, and “11”. The 2-bit codes “00”, “01”, “10”, “11”, and “11” represent the values 0, 1, 2, and 3, respectively. For example, the trust level value 0 (code “00”) can be associated with the highest trust level, and the trust level value 3 (code “11”) can be associated with the lowest trust level.

The inter-UE coordination information in step 202 may include additional information, such as the RSRP of the transmission associated with the SCI of the other UE(s) and the priority contained in that SCI. The inter-UE coordination information may indicate the cause of the non-preferred resource, e.g., due to a half-duplex problem or due to a hidden-node problem.

The UE 1B may consider the received inter-UE coordination information to select resources from the resource pool for sidelink transmission by the UE 1B. In other words, the UE 1B may perform the mode 2 resource selection at least based on the received inter-UE coordination information.

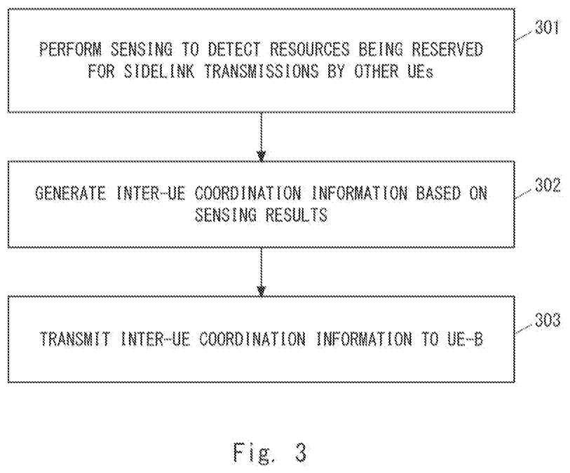

FIG. 3 shows an example of the operation of the UE 1A (i.e., the assisting UE). In step 301, the UE 1A performs sensing to detect resources being reserved for sidelink transmissions by other UEs. Specifically, during sensing, the UE 1A monitors each slot to receive SCIs (i.e., 1st-stage SCIs) from other UEs. Each SCI is transmitted via a Physical Sidelink Control Channel (PSCCH) in the same slot as the associated Physical Sidelink Shared Channel (PSSCH) and indicates the frequency resources of the PSSCH (i.e., one or more sub-channels) for the transmission of a transport block. The SCI also indicates the resource reservation for up to two retransmissions of this transport block. The SCI also indicates the priority of the associated PSSCH. In addition, if the UE reserves the PSSCH resources for the transmission of other transport blocks in the future, the SCI indicates the resource reservation interval. The resource reservation interval is also called the resource reservation period. The resource reservation interval indicates that the same set of sub-channels as specified in the SCI is also reserved for PSSCH transmissions in multiple slots that occur periodically during the resource reservation interval. In the current Release 16 specification, the possible values for the resource reservation interval are 0, 1-99, 100, 200, 300, 400, 500, 600, 700, 800, 900, and 1000 milliseconds.

In step 302, the UE 1A generates inter-UE coordination information based on the sensing results. In step 303, the UE 1A transmits the inter-UE coordination information to the UE 1B.

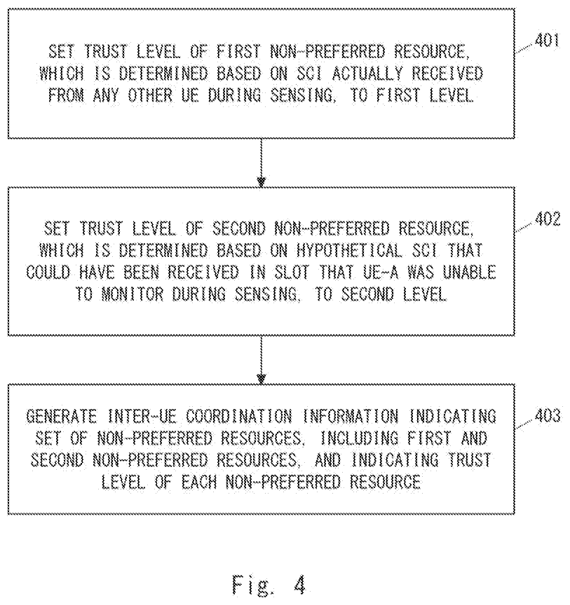

FIG. 4 shows a specific example of generating inter-UE coordination information based on sensing results. The process in FIG. 4 may be performed in step 302 of FIG. 3. In step 401, the UE 1A sets the trust level of a first non-preferred resource, which is determined based on an SCI actually received from any other UE during the sensing, to a first level (e.g., a trusted level). Specifically, the UE 1A checks the measured value of the RSRP of the transmission associated with an SCI actually received from any other UE. The UE 1A may measure the RSRP of Demodulation Reference Signal (DMRS) resource elements for the PSSCH associated with a received SCI, or the RSRP of DMRS resource elements for the PSCCH carrying that SCI. If the measured RSRP is higher than an RSRP threshold determined depending on the priority value indicated by that SCI, the UE 1A selects the candidate resources reserved by that SCI as the first non-preferred resources.

In step 402, the UE 1A sets the trust level of a second non-preferred resource, which is determined based on a hypothetical SCI that could have been received in a slot that the UE 1A was unable to monitor during the sensing, to a second level (e.g., an untrusted level) lower than the first level.

In an example, step 402 relates to half-duplex operation. Specifically, the UE 1A determines a slot sₘ that the UE 1A was unable to monitor in the sensing window because the UE 1A was transmitting. The UE 1A then selects, as the second non-preferred resources, all candidate resources (all sub-channels) in the slots Sₘ+q*PRIₙ that may have been reserved by hypothetical SCIs (i.e., 1st-stage SCIs) that may have been transmitted by other UEs in the slot sₘ. PRIₙ represents all possible values of the resource reservation interval. The parameter q is an integer equal to or greater than 1 and less than or equal to Q. Q is determined based on the end point T2 of the selection window.

In another example, step 402 relates to DRX operation. Specifically, the UE 1A determines a slot sⱼ that the UE 1A was unable to monitor in the sensing window because the UE 1A is in the DRX OFF duration. The UE 1A then selects, as the second non-preferred resources, all candidate resources (all sub-channels) in the slots Sⱼ+q*PRIₙ that may have been reserved by hypothetical SCIs (i.e., 1st-stage SCIs) that may have been transmitted by other UEs in the slot sⱼ. PRIₙ represents all possible values of the resource reservation interval. The parameter q is an integer equal to or greater than 1 and less than or equal to Q. Q is determined based on the end point T2 of the selection window.

The trust level of non-preferred resources based on slots that were not monitored because the UE 1A was transmitting may be different from the trust level of non-preferred resources based on slots that were not monitored because the UE 1A was in the DRX OFF duration. For example, the trust level for non-preferred resources based on slots that were not monitored because the UE 1A was transmitting may be higher than the trust level for non-preferred resources based on slots that were not monitored because the UE 1A was in the DRX OFF duration.

Note that this DRX is sidelink DRX. The DRX follows a DRX cycle that includes the ON duration and the OFF duration. The length of the DRX cycle is the sum of the ON duration and the OFF duration. In some implementations, when the DRX is activated, the UE 1A attempts to receive sidelink transmissions from other UEs at least during the ON duration, and is not required to do so during the OFF duration. The OFF duration can be rephrased as an opportunity for DRX. The ON duration may be the period of time during which the UE waits to receive a PSCCH (and a PSSCH). A PSCCH carries a 1st-stage SCI (e.g., SCI format 1-A). The 1st-stage SCI can be referred to as a scheduling assignment (SA) for PSSCH transmission. A PSSCH transmits a transport channel (i.e., Sidelink shared channel (SL-SCH)) that carries a transport block to which a Sidelink Control Channel (SCCH) or a Sidelink Traffic Channel (STCH) is mapped. A PSCCH is transmitted in the same slot as the associated PSSCH.

The sequence of steps 401 and 402 is not limited to the sequence shown in FIG. 4. Step 402 may be performed prior to or in parallel with step 401.

In step 403, the UE 1A generates inter-UE coordination information indicating the set of non-preferred resources, including the first and second non-preferred resources, and indicating the trust level of each non-preferred resource. The format of the inter-UE coordination information is not particularly restricted. For example, the inter-UE coordination information may indicate each trust level and a subset of non-preferred resources associated with that trust level. In addition, the inter-UE coordination information may also indicate, with respect to the first non-preferred resources, the measured value of the RSRP of the transmission associated with the corresponding SCI and the priority value indicated by that SCI. The inter-UE coordination information may also indicate the cause of the non-preferred resources, e.g., due to a half-duplex problem or due to a hidden-node problem.

Steps 401-403 in FIG. 4 can be modified as steps 401′-403′ described below to determine preferred resources.

In step 401′, the UE 1A sets the trust level of a first preferred resource, which is determined based on an SCI actually received from any other UE during the sensing, to a first level (e.g., trusted level). Specifically, the UE 1A may initially include all candidate resources in the selection window in a set of first preferred resources. The UE 1A then checks the measured value of the RSRP of the transmission associated with an SCI actually received from any other UE. The UE 1A may measure the RSRP of DMRS resource elements for the PSSCH associated with a received SCI, or the RSRP of DMRS resource elements for the PSCCH carrying that SCI. If the measured RSRP is higher than an RSRP threshold determined depending on the priority value indicated by that SCI, the UE 1A removes the candidate resources reserved by that SCI from the set of preferred resources.

In step 402′, the UE 1A sets the trust level of a second preferred resource, which is determined based on a hypothetical SCI that could have been received in a slot that the UE 1A was unable to monitor during the sensing, to a second level (e.g., an untrusted level) lower than the first level.

In an example, step 402′ relates to half-duplex operation. Specifically, the UE 1A determines a slot sₘ in the sensing window that the UE 1A was unable to monitor because the UE 1A was transmitting. The UE 1A then selects, as the second preferred resources, all candidate resources (all sub-channels) in the slots Sₘ+q*PRIₙ that may have been reserved by SCIs (i.e., 1st-stage SCIs) that may have been transmitted by other UEs in the slot sₘ. In other words, the UE 1A excludes these resources from the set of first preferred resources determined in step 401′ and moves them to the set of second preferred resources. PRIₙ represents all possible values of the resource reservation interval. The parameter q is an integer equal to or greater than 1 and less than or equal to Q. Q is determined based on the end point T2 of the selection window.

In another example, step 402′ relates to DRX operation. Specifically, the UE 1A determines a slot sⱼ that the UE 1A was unable to monitor in the sensing window because the UE 1A is in the DRX OFF duration. The UE 1A then selects, as the second preferred resources, all candidate resources (all sub-channels) in the slots Sⱼ+q*PRIₙ that may have been reserved by SCIs (i.e., 1st-stage SCIs) that may have been transmitted by other UEs in the slot sⱼ. In other words, the UE 1A excludes these resources from the set of first preferred resources determined in step 401′ and moves them to the set of second preferred resources. PRIₙ represents all possible values of the resource reservation interval. The parameter q is an integer equal to or greater than 1 and less than or equal to Q. Q is determined based on the end point T2 of the selection window.

The sequence of steps 401′ and 402′ is not restricted. Step 402′ may be performed prior to or in parallel with step 401′.

In step 403′, the UE 1A generates inter-UE coordination information indicating the set of preferred resources, including the first and second preferred resources, and indicating the trust level of each preferred resource. The format of the inter-UE coordination information is not particularly restricted. For example, the inter-UE coordination information may indicate each trust level and a subset of preferred resources associated with that trust level. In addition, the inter-UE coordination information may also indicate, with respect to the first preferred resources, the measured value of the RSRP of the transmission associated with the corresponding SCI and the priority value indicated by that SCI.

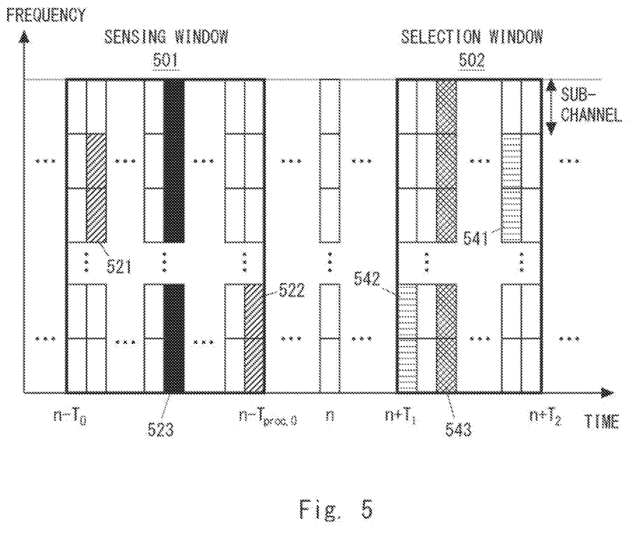

A specific example of the determination of preferred or non-preferred resources by the UE 1A is described below with reference to FIG. 5. The UE 1A is triggered to transmit inter-UE coordination information in slot n. This trigger can be based on an explicit request from the UE 1B (i.e., the assisted UE) or on the detection of a specific event by the UE 1A.

The sensing window 501 is a time interval defined by the range of slots [n-T₀, n-T_{proc, 0}]. To is an integer defined by the number of slots depending on the SCS configuration and is configured to a value (i.e., number of slots) corresponding to 1100 milliseconds or 100 milliseconds. T_{proc, 0} is the time required to complete the sensing procedure and is determined based on the subcarrier spacing (SCS). Specifically, T_{proc, 0} is one slot for 15 or 30 kHz SCS, two slots for 60 kHz SCS, and four slots for 120 kHz SCS.

The selection window 502 is a time interval defined by the range of slots [n+T₁, n+T₂]. T₁ is less than or equal to T_{proc, 1} and is selected by the UE 1A or the UE 1B. T_{proc, 1} is 3, 5, 9, or 17 slots for 15, 30, 60, or 120 kHz SCS, respectively. T₂ is selected by the UE 1A or the UE 1B and is greater than or equal to T₂ min and less than or equal to the remaining packet delay budget (PDB). The remaining PDB is the delay deadline by which the transport block of the UE 1B has to be transmitted. T₂ min depends on the priority of the transport block and the SCS, and can be 1, 5, 10, or 20 milliseconds.

The definitions of the sensing window 501 and the selection window 502 described above are based on the current definitions for Release 16 sidelink resource allocation mode 2. However, the definitions of the sensing window 501 and the selection window 502 may be changed to be different from those in Release 16.

Resources 521 (i.e., two consecutive sub-channels) and 522 (i.e., two consecutive sub-channels) in the sensing window 501 are resources for 1st-stage SCIs and their associated PSSCHs received by the UE 1A from other UE(s). On the other hand, resources 523 (i.e., all sub-channels of a single slot) in the sensing window 501 indicates a slot that the UE 1A could not monitor.

Resources 541 (i.e., two consecutive sub-channels) in the selection window 502 indicate resources reserved by the 1st-stage SCI received in the resource 521. Resources 542 (i.e., two consecutive sub-channels) in the selection window 502 indicate resources reserved by the 1st-stage SCI received in the resource 522. On the other hand, resources or a slot 543 (i.e., all sub-channels in a single slot) in the selection window 502 indicate a slot that may have been reserved by hypothetical 1st-stage SCIs of other UEs in the unmonitored resource 523.

According to the operation of steps 401-403 in FIG. 4, the UE 1A includes the resources 541 and 542 in the set of first non-preferred resources and includes the resources 543 in the set of second non-preferred resources. In contrast, according to the operation of steps 401′-403′ of the variant, the UE 1A includes the resources of the selection window 502, excluding the resources 541, 542, and 543, in the set of first preferred resources, and includes the resource 543 in the set of the second preferred resources.

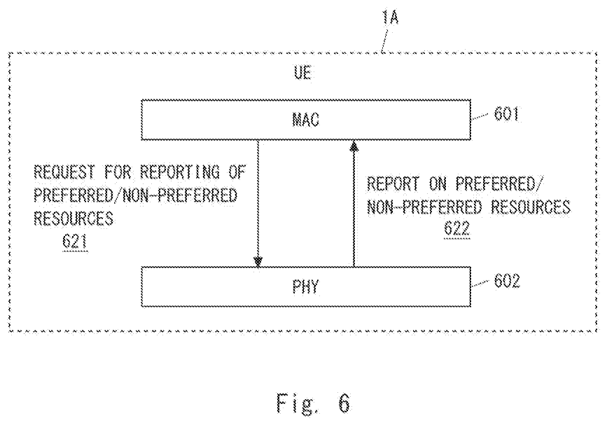

FIG. 6 shows an example of the operation of the UE 1A (i.e., the assisting UE). In some implementations, a physical layer 602 of the UE 1A may perform sensing and selection of preferred or non-preferred resources, and a MAC layer 601 of the UE 1A may generate inter-UE coordination information. In this case, the MAC layer 601 may request (621) the physical layer 602 for a report of a subset of resources. The MAC layer 601 may indicate to the physical layer 602 whether this report is for resource selection for sidelink transmission by the UE 1A or for inter-UE coordination. If the request indicates that the report is for inter-UE coordination, the physical layer 602 may report (622) to the MAC layer 601 a set of preferred or non-preferred resources and the trust (or importance) level of each resource. Alternatively, the physical layer 602 may report a set of first preferred or non-preferred resources and a set of second preferred or non-preferred resources to the MAC layer 601. The MAC layer 601 may then determine the first trust level for the set of first preferred or non-preferred resources, and further determine the second trust level for the set of second preferred or non-preferred resources.

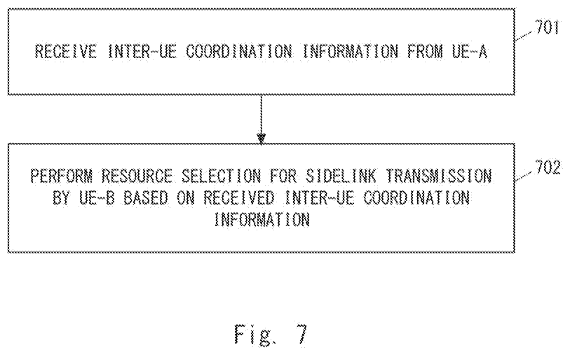

FIG. 7 shows an example of the operation of the UE 1B (i.e., the assisted UE). In step 701, the UE 1B receives inter-UE coordination information from the UE 1A (i.e., the assisting UE). In step 702, the UE 1B performs the mode 2 resource selection for sidelink transmission by the UE 1B based at least on the received inter-UE coordination information.

If the inter-UE coordination information specifies a set of preferred resources, the UE 1B may operate as described below. The UE 1B selects resources for sidelink transmission from the common part (or intersection) between the set of candidate resources obtained by the UE 1B through its own sensing and the set of preferred resources with the first level (e.g., trusted level) specified in the inter-UE coordination information. If this common part is not present, the UE 1B selects resources for sidelink transmission from the common part (or intersection) between the set of candidate resources obtained by its own sensing and the set of preferred resources with the second level (e.g., untrusted level) specified in the inter-UE coordination information. If there is no common part, the UE 1B selects resources for sidelink transmission from the set of candidate resources obtained by its own sensing.

On the other hand, if the inter-UE coordination information specifies a set of non-preferred resources, the UE 1B may operate as described below. The UE 1B excludes entire the set of non-preferred resources specified in the inter-UE coordination information from the set of candidate resources obtained by the UE 1B through its own sensing, and performs resource selection from the final set of candidate resources obtained. If nothing remains in the final set of candidate resources, the UE 1B excludes only the set of first level (e.g., trusted level) non-preferred resources specified in the inter-UE coordination information from the set of candidate resources obtained through its own sensing, and performs resource selection from the obtained final set of candidate resources. If still nothing remains in the final set of candidate resources, the UE 1B selects resources for sidelink transmission from the set of candidate resources obtained by its own sensing, without considering the non-preferred resources indicated in the inter-UE coordination information. As described above, the inter-UE coordination information may indicate, with respect to the first level non-preferred resources, the measured value of the RSRP of the transmission associated with the corresponding SCI and the priority value indicated by that SCI. In this case, the UE 1A may consider these to determine whether to exclude the first level non-preferred resources. Specifically, if the measured RSRP is higher than an RSRP threshold determined depending on the priority value indicated by the SCI, the UE 1A may exclude the corresponding first non-preferred resources from the set of candidate resources.

According to the operation of the UE 1A and the UE 1B described in this example embodiment, the UE 1B can distinguish between the trust or importance levels of multiple preferred or non-preferred resources and can determine which preferred or non-preferred resources should be considered in its own resource selection.

Additionally, if the UE 1A is configured with DRX, the UE 1A may not perform any receive processing during the DRX off duration within the sensing window. This could result in a significant increase of slots in the sensing window where the UE 1A does not receive SCIs from other UEs. If the preferred or non-preferred resources for the inter-UE coordination scheme 1 are determined based on hypothetical SCIs that could have been received in slots within the DRX OFF duration, this may result in a significant decrease of the preferred resources or a significant increase of the non-preferred resources. According to this example embodiment, the UE 1A can include reserved resources based on hypothetical SCIs in the set of second level preferred resources. This helps to reduce the reduction of preferred resources. Alternatively, the UE 1A can include reserved resources based on hypothetical SCIs in the set of second level non-preferred resources. This can help to reduce the number of first level non-preferred resources.

### Second Example Embodiment

The example of a radio communication system according to this example embodiment is the same as the example described with reference to FIG. 1.

In this embodiment, the UE 1A and the UE 1B support at least the inter-UE coordination scheme 1. The UE 1A and the UE 1B may support the inter-UE coordination scheme 2.

In the inter-UE coordination scheme 1, the inter-UE coordination information sent by the UE 1A to the UE 1B indicates one or both of a set of preferred resources and a set of non-preferred resources for transmission by the UE 1B. For example, in Scheme 1, the UE 1B may (re) select resources for sidelink transmission by the UE 1B based at least on the inter-UE coordination information from the UE 1A. More specifically, the UE 1B may select resources for sidelink transmission from the common part (i.e., the intersection) between the set of candidate resources obtained by the UE 1B through its own sensing and the set of preferred resources indicated in the inter-UE coordination information. Alternatively, the UE 1B may exclude the set of non-preferred resources indicated in the inter-UE coordination information from the set of candidate resources obtained by the UE 1B through its own sensing, and perform resource selection from the final set of candidate resources.

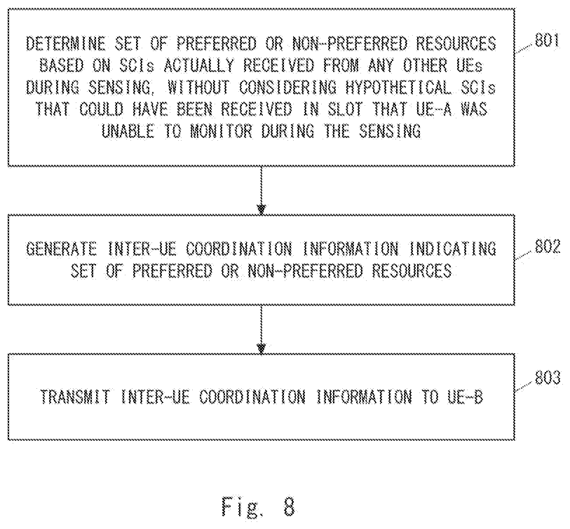

FIG. 8 shows a specific example of the generation and transmission of inter-UE coordination information by the UE 1A (i.e., the assisting UE) for the inter-UE coordination scheme 1. As described in the first example embodiment, the UE 1A may generate and transmit inter-UE coordination information to the UE 1B in response to the detection of a certain event by the UE 1A. Alternatively, the UE 1A may generate and send inter-UE coordination information to the UE 1B (i.e., the assisted UE) in response to a request or trigger from the UE 1B. The request from the UE 1B may specify parameters related to resource selection by the UE 1B. These parameters may include a parameter indicating a time interval for defining a plurality of candidate resources from which the UE 1A will select preferred or non-preferred resources. This time interval may be referred to as a selection window. In particular, these parameters may include the parameters required for sensing for the mode 2 resource selection in the current Release 16. More specifically, these parameters may include one or any combination of a resource pool used by the UE 1B, a priority, a remaining PDB, the number of sub-channels used for PSSCH/PSCCH transmission, and a resource reservation interval. Additionally or alternatively, the request from the UE 1B may specify the type of inter-UE coordination information requested (e.g., a set of preferred or a set of non-preferred resources, or scheme 1 or scheme 2).

In step 801, the UE 1A determines a set of preferred or non-preferred resources based on SCIs actually received from any other UEs during the sensing, without considering hypothetical SCIs that could have been received in a slot that the UE 1A was unable to monitor during the sensing.

In step 802, the UE 1A generates inter-UE coordination information indicating the determined set of preferred or non-preferred resources. The format of the inter-UE coordination information is not particularly restricted. The inter-UE coordination information may also indicate, for each preferred or non-preferred resource, the measured value of the RSRP of the transmission associated with the corresponding SCI and the priority value indicated by that SCI. The inter-UE coordination information may indicate the cause of the non-preferred resource, e.g., due to a half-duplex problem or due to a hidden-node problem.

In step 803, the UE 1A transmits the inter-UE coordination information to the UE 1B (i.e., the assisted UE). The container used to carry the inter-UE coordination information may be physical layer signaling, layer 2 signaling, or PC5 RRC signaling. The physical layer signaling may be, for example, 1st-stage SCI (e.g., SCI format 1-A), 2nd-stage SCI (e.g., SCI format 2-A, 2-B), or a PSFCH-like format. The layer 2 signaling may be a MAC CE.

The inter-UE coordination information is considered by the UE 1B in the mode 2 resource selection for sidelink transmission by the UE 1B. If the inter-UE coordination information specifies a set of preferred resources, the UE 1B may operate as described below. The UE 1B selects resources for sidelink transmission from the common part (or intersection) between the set of candidate resources obtained by the UE 1B through its own sensing and the set of preferred resources specified in the inter-UE coordination information. If this common part is not present, the UE 1B selects resources for sidelink transmission from the set of candidate resources obtained by its own sensing.

On the other hand, if the inter-UE coordination information specifies a set of non-preferred resources, the UE 1B may operate as described below. The UE 1B excludes the entire set of non-preferred resources specified in the inter-UE coordination information from the set of candidate resources obtained by the UE 1B through its own sensing, and performs resource selection from the final set of candidate resources obtained. If nothing remains in the final set of candidate resources, the UE 1B selects resources for sidelink transmission from the set of candidate resources obtained by its own sensing, without considering the non-preferred resources indicated in the inter-UE coordination information. As described above, the inter-UE coordination information may indicate, with respect to the non-preferred resources, the measured value of the RSRP of the transmission associated with the corresponding SCI and the priority value indicated by that SCI. In this case, the UE 1A may consider these to determine whether to exclude the non-preferred resources. Specifically, if the measured RSRP is higher than the RSRP threshold determined depending on the priority value indicated by the SCI, the UE 1A may exclude the corresponding non-preferred resources from the set of candidate resources.

Similar to what is described with reference to FIG. 6, in this example embodiment, a physical layer of the UE 1A may perform sensing and selection of preferred or non-preferred resources, and a MAC layer of the UE 1A may generate inter-UE coordination information. In this case, the MAC layer may request the physical layer for a report of a subset of resources. The MAC layer may indicate to the physical layer whether this report is for resource selection for sidelink transmission by the UE 1A or for inter-UE coordination. If the request indicates that the report is for inter-UE coordination, the physical layer may report a set of preferred or non-preferred resources to the MAC layer according to the operation in FIG. 8.

In contrast, if the request from the MAC layer indicates that the report is for resource selection for sidelink transmission by the UE 1A, the physical layer may determine a set of candidate resources for sidelink transmission by the UE 1A based on both hypothetical SCIs and actual SCIs received, and report this to the MAC layer.

The operations of UE 1A and UE 1B described in this example embodiment can help mitigate the reduction of preferred resources. Alternatively, they can contribute to the reduction of non-preferred resources.

### Third Example Embodiment

The example of a radio communication system according to this example embodiment is the same as the example described with reference to FIG. 1.

In this embodiment, the UE 1A and the UE 1B support at least the inter-UE coordination scheme 2. The UE 1A and the UE 1B may support the inter-UE coordination scheme 1.

In the inter-UE coordination scheme 2, inter-UE coordination information sent from the UE 1A to the UE 1B indicates the existence (or presence) of an expected or potential resource conflict on the resource(s) indicated (or reserved) by Sidelink Control Information (SCI) of the UE 1B. Additionally or alternatively, in the scheme 2, the inter-UE coordination information sent from the UE 1A to the UE 1B indicates the presence of a resource conflict detected by the UE 1A on the resource(s) indicated (or reserved) by the SCI of the UE 1B. For example, in the scheme 2, the UE 1B can determine resources to be reselected, or the need for retransmission, based at least on the inter-UE coordination information from the UE 1A.

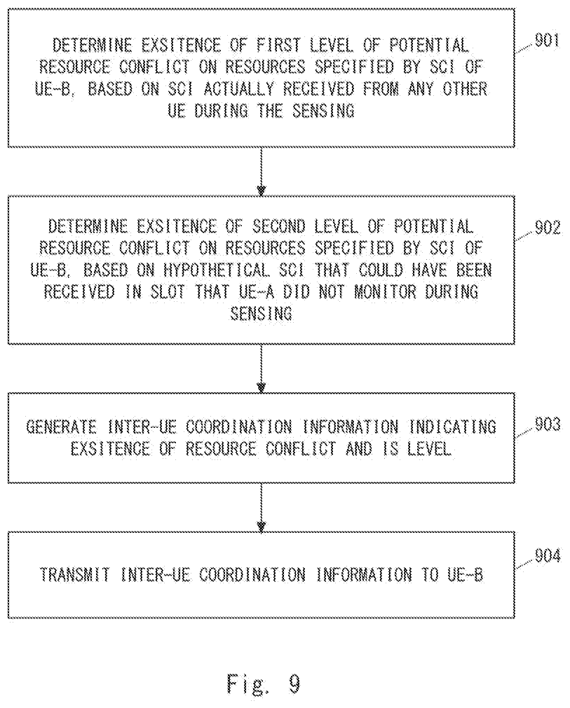

FIG. 9 shows a specific example of the generation and transmission of inter-UE coordination information by the UE 1A (i.e., the assisting UE) for the inter-UE coordination scheme 2. The UE 1A may generate and transmit inter-UE coordination information to the UE 1B in response to the detection of a certain event (e.g., determination of the existence of a resource conflict) by the UE 1A. Alternatively, the UE 1A may generate and transmit inter-UE coordination information to the UE 1B in response to a request from the UE 1B (i.e., the assisted UE).

In step 901, the UE 1A determines the existence of a first level of potential resource conflicts on the resources indicated (or reserved) by an SCI of the UE 1B, based on SCIs actually received from any other UE(s) during the sensing. The potential resource conflict may be referred to as an expected resource conflict. The first level may be referred to as the first trust level, the first importance level, the first priority level, or the first priority. Specifically, the UE 1A determines whether any of the resources specified or reserved by the SCI received from the UE 1B overlap (or conflict) with any of the resources specified or reserved by SCIs received from any other UEs. If they overlap, the UE 1A determines the existence of the first level of potential resource conflicts.

In step 902, based on hypothetical SCIs that could have been received in slots that the UE 1A did not monitor during the sensing, the UE 1A determines the presence of a second level of potential resource conflicts on the resources indicated (or reserved) by the SCI of the UE 1B. The second level is lower than the first level determined in step 901. The second level may be referred to as the second trust level, the second importance level, the second priority level, or the second priority. Specifically, the UE 1A determines whether any of the resources specified or reserved by the SCI received from the UE 1B overlap (or conflict) with the resources specified or reserved by a hypothetical SCI. If they overlap, the UE 1A determines the existence of the second level of potential resource conflicts.

In an example, step 902 relates to half-duplex operation. Specifically, the UE 1A determines a slot sₘ that the UE 1A was unable to monitor in the sensing window because the UE 1A was transmitting. The UE 1A then determines whether any of all candidate resources (all sub-channels) in the slots Sₘ+q*PRIₙ that may have been reserved by hypothetical SCIs (i.e., 1st-stage SCIs) that may have been transmitted by other UEs in the slot sₘ overlaps with any of the resources indicated by the SCI of the UE 1B. If they overlap, the UE 1A determines the existence of the second level of potential resource conflicts. PRIₙ represents all possible values of the resource reservation interval. The parameter q is an integer equal to or greater than 1 and less than or equal to Q. Q is determined based on the end point T₂ of the selection window.

In another example, step 902 relates to DRX operation. Specifically, the UE 1A determines a slot sⱼ that the UE 1A was unable to monitor in the sensing window because the UE 1A is in the DRX OFF duration. The UE 1A then determines whether any of all candidate resources (all sub-channels) in the slots Sⱼ+q*PRIₙ that may have been reserved by hypothetical SCIs (i.e., 1st-stage SCIs) that may have been transmitted by other UEs in the slot sⱼ overlaps with any of the resources indicated by the SCI of the UE 1B. If they overlap, the UE 1A determines the existence of the second level of potential resource conflicts. PRIₙ represents all possible values of the resource reservation interval. The parameter q is an integer equal to or greater than 1 and less than or equal to Q. Q is determined based on the end point T₂ of the selection window.

The trust level of potential resource conflicts determined based on slots that could not be monitored because the UE 1A was transmitting may be different from the trust level of resource conflicts determined based on slots that could not be monitored because the UE 1A was in the DRX OFF duration. For example, the trust level of potential resource conflicts based on slots that could not be monitored because the UE 1A was transmitting may be higher than the trust level of potential resource conflicts based on slots that could not be monitored because the UE 1A was in the DRX OFF duration. In particular, the trust level of potential resource conflicts based on slots that could not be monitored because the UE 1A was transmitting may be set to the second level, while the trust level of potential resource conflicts based on slots that could not be monitored because the UE 1A was in the DRX OFF duration may be set to the third level, which is lower than the second level.

Note that this DRX is sidelink DRX. The DRX follows a DRX cycle that includes the ON duration and the OFF duration. The length of the DRX cycle is the sum of the ON duration and the OFF duration. In some implementations, when the DRX is activated, the UE 1A attempts to receive sidelink transmissions from other UEs at least during the ON duration, and is not required to do so during the OFF duration. The OFF duration can be rephrased as an opportunity for DRX. The ON duration may be the period of time during which the UE waits to receive a PSCCH (and a PSSCH). A PSCCH carries a 1st-stage SCI (e.g., SCI format 1-A). The 1st-stage SCI can be referred to as a scheduling assignment (SA) for PSSCH transmission. A PSSCH transmits a transport channel (i.e., Sidelink shared channel (SL-SCH)) that carries a transport block to which a Sidelink Control Channel (SCCH) or a Sidelink Traffic Channel (STCH) is mapped. A PSCCH is transmitted in the same slot as the associated PSSCH.

The sequence of steps 901 and 902 is not limited to the sequence shown in FIG. 9. Step 902 may be performed prior to or in parallel with step 901. Alternatively, if the presence of the first level of potential resource conflict is determined in step 901, then step 902 may not need to be performed.

In an example, the values of the first and second trust levels may be “trusted” and “untrusted”. The values of the first and second importance levels may be “important” and “unimportant”. The values of the first and second priority levels (or priority) may be “high (priority)” and “low (priority)”. For example, if the number of trust levels is four, then the trust levels can be “00”, “01”, “10”, and “11”. The 2-bit codes “00”, “01”, “10”, “11”, and “11” represent the values 0, 1, 2, and 3, respectively. For example, the trust level value 0 (code “00”) can be associated with the highest trust level, and the trust level value 3 (code “11”) can be associated with the lowest trust level. For example, the first trust level may be the value “00”, the second trust level may be the value “01”, and the third trust level may be the value “10”.

In step 903, the UE 1A generates inter-UE coordination information indicating the presence of potential resource conflicts and their levels as determined in one or both of steps 901 and 902.

In step 904, the UE 1A transmits the inter-UE coordination information to the UE 1B (i.e., the assisted UE). The container used to carry the inter-UE coordination information may be physical layer signaling or layer 2 signaling. The physical layer signaling may be, for example, 1st-stage SCI (e.g., SCI format 1-A), 2nd-stage SCI (e.g., SCI format 2-A, 2-B), or a PSFCH-like format. The layer 2 signaling may be a MAC CE.

The UE 1B may determine resources to be reselected at least based on the inter-UE coordination information received from the UE 1A. The UE 1B may determine resources to be reselected based on the trust level contained in the inter-UE coordination information received from the UE 1A. For example, if the UE 1B is notified of the presence of a first level of potential resource conflict, the UE 1B may perform resource reselection to avoid the resource conflict. On the other hand, if the UE 1B is notified of the presence of a second level of potential resource conflict, the UE 1B may decide whether to perform resource reselection based on the priority of the UE 1B's transport block to be transmitted on the resources where the potential resource conflict exists. For example, the UE 1B may decide to perform resource reselection if the priority of the UE 1B's transport block to be transmitted on the resources where the potential resource conflict exists is higher than a threshold value.

### Fourth Example Embodiment

The example of a radio communication system according to this example embodiment is the same as the example described with reference to FIG. 1.

In this embodiment, the UE 1A and the UE 1B support at least the inter-UE coordination scheme 2. The UE 1A and the UE 1B may support the inter-UE coordination scheme 1.

In the inter-UE coordination scheme 2, inter-UE coordination information sent from the UE 1A to the UE 1B indicates the existence (or presence) of an expected or potential resource conflict on the resource(s) indicated (or reserved) by Sidelink Control Information (SCI) of the UE 1B. Additionally or alternatively, in the scheme 2, the inter-UE coordination information sent from the UE 1A to the UE 1B indicates the presence of a resource conflict detected by the UE 1A on the resource(s) indicated (or reserved) by the SCI of the UE 1B. For example, in the scheme 2, the UE 1B can determine resources to be reselected, or the need for retransmission, based at least on the inter-UE coordination information from the UE 1A.

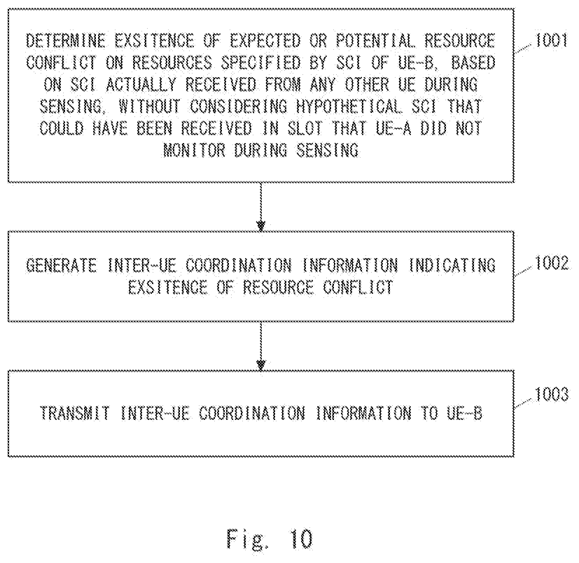

FIG. 10 shows a specific example of the generation and transmission of inter-UE coordination information by the UE 1A (i.e., the assisting UE) for the inter-UE coordination scheme 2. The UE 1A may generate and transmit inter-UE coordination information to the UE 1B in response to the detection of a certain event (e.g., determination of the existence of a resource conflict) by the UE 1A. Alternatively, the UE 1A may generate and transmit inter-UE coordination information to the UE 1B in response to a request from the UE 1B (i.e., the assisted UE).

In step 1001, the UE 1A determines the existence of potential resource conflicts on the resources indicated (or reserved) by an SCI of the UE 1B, based on SCIs actually received from any other UE(s) during the sensing, without considering hypothetical SCIs that could have been received in slots that the UE 1A did not monitor during the sensing.

In step 1002, the UE 1A generates inter-UE coordination information indicating the presence of the detected resource conflicts.

In step 1003, the UE 1A transmits the inter-UE coordination information to the UE 1B (i.e., the assisted UE). The container used to carry the inter-UE coordination information may be physical layer signaling or layer 2 signaling. The physical layer signaling may be, for example, 1st-stage SCI (e.g., SCI format 1-A), 2nd-stage SCI (e.g., SCI format 2-A, 2-B), or a PSFCH-like format. The layer 2 signaling may be a MAC CE. The inter-UE coordination information in step 1003 may include an indication of whether the resource conflicts are due to half-duplex or resource collision.

The UE 1B may determine resources to be reselected at least based on the inter-UE coordination information received from the UE 1A.

If the existence of expected or potential resource conflicts for the inter-UE coordination scheme 2 is determined based on hypothetical SCIs that could have been received in slots within the DRX OFF duration, this may result in a significant increase in resource conflicts. In this regard, the operations of the UE 1A and the UE 1B described in this example embodiment can help to mitigate the increase of resource conflicts.

### Fifth Example Embodiment

The example of a radio communication system according to this example embodiment is the same as the example described with reference to FIG. 1. This example embodiment provides details of the operation of the UE 1B (i.e., the assisted UE) in the inter-UE coordination scheme 1. More specifically, this example embodiment provides the conditions for the UE 1B (i.e., the assisted UE) to send a request or trigger for inter-UE coordination to the UE 1A (i.e., the assisting UE).

In some implementations, the UE 1B sends a request or trigger for inter-UE coordination to the UE 1A if the number of candidate resources obtained by its own sensing is greater than a threshold. In other words, the UE 1B sends a request or trigger for inter-UE coordination to the UE 1A if the number of candidate resources obtained by its own sensing is greater than a threshold value. The UE 1B then receives the inter-UE coordination information from the UE 1A. If the inter-UE coordination information specifies a set of preferred resources, the UE 1B may select resources for sidelink transmission from the common part (or intersection) between the set of candidate resources obtained by the UE 1B through its own sensing and the set of preferred resources specified in the inter-UE coordination information. If the inter-UE coordination information specifies a set of non-preferred resources, the UE 1B may exclude the set of non-preferred resources indicated in the inter-UE coordination information from the set of candidate resources obtained by the UE 1B through its own sensing, and perform resource selection from the final set of candidate resources.

On the other hand, if the number of candidate resources obtained by its own sensing is smaller than the threshold, the UE 1B may select resources for sidelink transmission from the candidate resources obtained by its own sensing without requesting or triggering inter-UE coordination to the UE 1A. In this situation, the UE 1B may not obtain a sufficient number of final candidate resources when it considers the set of preferred or non-preferred resources indicated by the UE 1A, and as a result the inter-UE coordination information may be ignored. Thus, this behavior can help to avoid ineffective inter-UE signaling.

In other implementations, the UE 1B may send a request or trigger for inter-UE coordination to the UE 1A, if the number of candidate resources obtained by its own sensing is less than a threshold. In other words, the UE 1B may send a request or trigger for inter-UE coordination to the UE 1A if the number of candidate resources obtained by its own sensing is less than a threshold value. In this case, the UE 1B may select resources for sidelink transmission from the union set of the set of candidate resources obtained by the UE 1B through its own sensing and the set of preferred resources indicated in the inter-UE coordination information. This contributes to increasing the number of final candidate resources for the mode 2 resource selection by the UE 1B.

On the other hand, if the number of candidate resources obtained by its own sensing is greater than the threshold, the UE 1B may select resources for sidelink transmission from the candidate resources obtained by its own sensing without requesting or triggering inter-UE coordination to the UE 1A.

In yet other implementations, the UE 1B may operate as described below. The UE 1B generates a set of first level non-preferred resources and a set of second level non-preferred resources based on its own sensing results. The set of first level non-preferred resources is a set of first non-preferred resources determined based on SCIs actually received from other UEs during the sensing by the UE 1B. The set of second level non-preferred resources is a set of second non-preferred resources determined based on hypothetical SCIs that could have been received in slots that the UE 1B was unable to monitor during the sensing (referred to as Set A). The UE 1B excludes these first and second levels of non-preferred resources from the set of candidate resources. If the number of candidate resources obtained is greater than a threshold, the UE 1B selects resources for sidelink transmission from the candidate resources obtained by its own sensing, without requesting or triggering inter-UE coordination to the UE 1A. On the other hand, if the number of candidate resources obtained is less than the threshold, the UE 1B sends a request or trigger for inter-UE coordination to the UE 1A. The UE 1B receives inter-UE coordination information from the UE 1A. This inter-UE coordination information indicates a set of non-preferred resources based on the sensing results by the UE 1A. The UE 1B selects the resources that are included in the set of second non-preferred resources (Set A) of the UE 1B, but are not included in the non-preferred resources specified by the UE 1A. The UE 1B then returns (or adds) the selected resources to the set of candidate resources, thereby increasing the number of candidate resources. The UE 1B then selects resources for sidelink transmission from the candidate resources.

This example embodiment may be implemented in combination with the first or second example embodiment. Specifically, the UE 1B may send the request or trigger of step 201 in FIG. 2 to the UE 1A if one of the conditions described in this example embodiment is met. Similarly, the UE 1B may send a request or trigger to the UE 1A to trigger the operation of the UE 1A shown in FIG. 8 if one of the conditions described in this example embodiment is met.

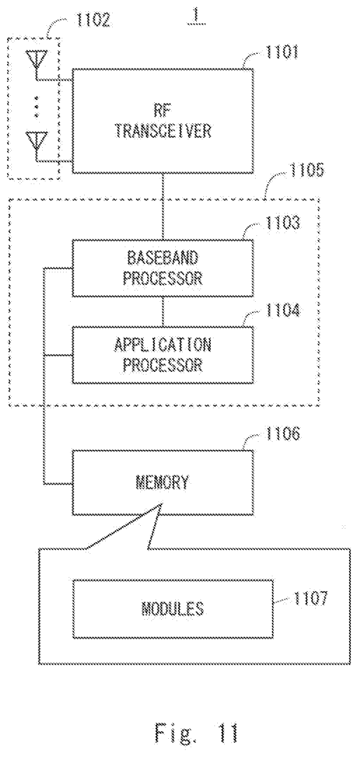

The following provides configuration examples of the UE 1 according to the above described example embodiments. FIG. 11 is a block diagram showing an example configuration of the UE 1. Both the UE 1A (assisting UE) and the UE 1B (assisted UE) described above may have the configuration shown in FIG. 11. The radio frequency (RF) transceiver 1101 performs analog RF signal processing to communicate with a RAN node. The RF transceiver 1101 may include a plurality of transceivers. The analog RF signal processing performed by the RF transceiver 1101 includes frequency up-conversion, frequency down-conversion, and amplification. The RF transceiver 1101 is coupled to the antenna array 1102 and the baseband processor 1103. The RF transceiver 1101 receives modulation symbol data (or OFDM symbol data) from the baseband processor 1103, generates a transmission RF signal, and supplies the transmission RF signal to the antenna array 1102. The RF transceiver 1101 generates a baseband reception signal based on the reception RF signal received by the antenna array 1102 and supplies the baseband reception signal to the baseband processor 1103. The RF transceiver 1101 may include an analog beamformer circuit for beamforming. The analog beamformer circuit includes, for example, a plurality of phase shifters and a plurality of power amplifiers.

The baseband processor 1103 performs digital baseband signal processing (data-plane processing) and control-plane processing for wireless communication. The digital baseband signal processing includes (a) data compression/decompression, (b) data segmentation/concatenation, (c) transmission format (transmission frame) composition/decomposition, (d) channel encoding/decoding, (e) modulation (i.e., symbol mapping)/demodulation, and (f) Inverse Fast Fourier Transform (IFFT) generation of OFDM symbol data (baseband OFDM signal). On the other hand, the control-plane processing includes communication management of layer 1 (e.g., transmission power control), layer 2 (e.g., radio resource management, and hybrid automatic repeat request (HARQ) processing), and layer 3 (e.g., signaling regarding attachment, mobility, and call management).

For example, the digital baseband signal processing performed by the baseband processor 1103 may include signal processing in the Service Data Adaptation Protocol (SDAP) layer, Packet Data Convergence Protocol (PDCP) layer, Radio Link Control (RLC) layer, Medium Access Control (MAC) layer, and Physical (PHY) layer. The control-plane processing performed by the baseband processor 1103 may also include processing of Non-Access Stratum (NAS) protocols, Radio Resource Control (RRC) protocols, MAC Control Elements (CEs), and Downlink Control Information (DCIs).

The baseband processor 1103 may perform Multiple Input Multiple Output (MIMO) encoding and precoding for beamforming. The baseband processor 1103 may include a modem processor (e.g., Digital Signal Processor (DSP)) that performs the digital baseband signal processing and a protocol stack processor (e.g., Central Processing Unit (CPU) or Micro Processing Unit (MPU)) that performs the control-plane processing. In this case, the protocol stack processor performing the control-plane processing may be integrated with an application processor 1104 described later.

The application processor 1104 may also be referred to as a CPU, an MPU, a microprocessor, or a processor core. The application processor 1104 may include a plurality of processors (processor cores). The application processor 1104 loads a system software program (Operating System (OS)) and various application programs (e.g., a voice call application, a web browser, a mailer, a camera operation application, a music player application) from a memory 1106 or from another memory (not shown) and executes these programs, thereby providing various functions of the UE 1.

In some implementations, as represented by the dashed line (1105) in FIG. 11, the baseband processor 1103 and the application processor 1104 may be integrated on a single chip. In other words, the baseband processor 1103 and the application processor 1104 may be implemented in a single System on Chip (SoC) device 1105. A SoC device may be referred to as a system Large Scale Integration (LSI) or a chipset.

The memory 1106 is a volatile memory or a non-volatile memory, or a combination thereof. The memory 1106 may include a plurality of physically independent memory devices. The volatile memory is, for example, Static Random Access Memory (SRAM), Dynamic RAM (DRAM), or a combination thereof. The non-volatile memory may be a Mask Read Only Memory (MROM), an Electrically Erasable Programmable ROM (EEPROM), a flash memory, a hard disk drive, or any combination thereof. The memory 1106 may include, for example, an external memory device that can be accessed by the baseband processor 1103, the application processor 1104, or the SoC 1105. The memory 1106 may include an internal memory device that is integrated into the baseband processor 1103, the application processor 1104, or the SoC 1105. Further, the memory 1106 may include a memory in a Universal Integrated Circuit Card (UICC).

The memory 1106 may store one or more software modules (computer programs) 1107 including instructions and data for processing by the UE 1 described in the above example embodiments. In some implementations, the baseband processor 1103 or the application processor 1104 may load the software module(s) 1107 from the memory 1106 and execute the loaded software module(s) 1107, thereby performing the processing of the UE 1 described in the above example embodiments with reference to the drawings.

The control-plane processing and operations performed by the UE 1 described in the above embodiments can be achieved by elements other than the RF transceiver 1101 and the antenna array 1102, i.e., achieved by the memory 1106, which stores the software modules 1107, and one or both of the baseband processor 1103 and the application processor 1104.

As described using FIG. 11, the one or more processors of the UE 1 according to the example embodiments described above can execute one or more programs, containing a set of instructions, to cause a computer to perform an algorithm described with reference to the drawings. Each of these programs contains a set of instructions (or software codes) that, when loaded into a computer, causes the computer to perform one or more of the functions described in the example embodiments. Each of these programs may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray (registered mark) disc or other optical disk storage, magnetic cassettes, magnetic tape, magnetic disk storage or other magnetic storage devices. Each program may be transmitted on a transitory computer readable medium or a communication medium. By way of example, and not limitation, transitory computer readable media or communication media can include electrical, optical, acoustical, or other form of propagated signals.

The above-described example embodiments are merely examples of applications of the technical ideas obtained by the inventor. These technical ideas are not limited to the above-described example embodiments and various modifications can be made thereto.

For example, the whole or part of the example embodiments disclosed above can be described as, but not limited to, the following supplementary notes.

### (Supplementary Note 1)

A first radio terminal comprising:
at least one radio transceiver; and
at least one processor coupled to the at least one radio transceiver and configured to:
   perform sensing to detect resources reserved for sidelink transmission by one or more other radio terminals; and
   transmit, to the second radio terminal, inter-terminal coordination information generated based on a result of the sensing, wherein
the inter-terminal coordination information indicates a first set of preferred resources for sidelink transmission by the second radio terminal or a second set of non-preferred resources for sidelink transmission by the second radio terminal, and
the inter-terminal coordination information indicates a trust level of each resource in the first or second set.

### (Supplementary Note 2)

The first radio terminal according to Supplementary Note 1, wherein the at least one processor is configured to:
set, to a first level, the trust level of a first preferred or non-preferred resource determined based on sidelink control information actually received from another radio terminal during the sensing; and
set, to a second level lower than the first level, the trust level of a second preferred or non-preferred resource determined based on hypothetical sidelink control information that could have been received in a slot that the first radio terminal was unable to monitor during the sensing.

### (Supplementary Note 3)

The first radio terminal according to Supplementary Note 2, wherein the inter-terminal coordination information further indicates, with respect to the first preferred or non-preferred resource, a measurement result of Reference Signal Received Power (RSRP) of a transmission associated with the sidelink control information and a priority of sidelink transmission by the other radio terminal contained in the sidelink control information.

### (Supplementary Note 4)

The first radio terminal according to any one of Supplementary Notes 1 to 3, wherein the inter-terminal coordination information is considered by the second radio terminal in resource selection for sidelink transmission by the second radio terminal.

### (Supplementary Note 5)

The first radio terminal according to any one of Supplementary Notes 1 to 4, wherein the at least one processor is configured to:
receive a request for inter-terminal coordination from the second radio terminal; and
transmit the inter-terminal coordination information to the second radio terminal in response to receiving the request.

### (Supplementary Note 6)

The first radio terminal according to Supplementary Note 5, wherein the request includes information indicating a time interval for defining a plurality of candidate resources from which the first radio terminal selects the first or second set.

### (Supplementary Note 7)

The first radio terminal according to any one of Supplementary Notes 1 to 6, wherein the at least one processor is configured to provide a Medium Access Control (MAC) layer, and a physical layer providing physical layer procedures, wherein
the MAC layer is configured to request the physical layer for a report of a subset of resources, and
the MAC layer is configured to indicate to the physical layer whether the report is for resource selection for sidelink transmission by the first radio terminal or for inter-terminal coordination.

### (Supplementary Note 8)

The first radio terminal according to Supplementary Note 7, wherein the physical layer is configured to report the first or second set and the trust level of each resource in the first or second set to the MAC layer, if the request indicates that the report is for inter-terminal coordination.

### (Supplementary Note 9)

The first radio terminal according to any one of Supplementary Notes 1 to 8, wherein
each resource is one or more sub-channels, and
each sub-channel contains a plurality of resource blocks in a single slot.

### (Supplementary Note 10)

A method performed by a first radio terminal, the method comprising:
performing sensing to detect resources reserved for sidelink transmission by one or more other radio terminals; and
transmitting, to the second radio terminal, inter-terminal coordination information generated based on a result of the sensing, wherein
the inter-terminal coordination information indicates a first set of preferred resources for sidelink transmission by the second radio terminal or a second set of non-preferred resources for sidelink transmission by the second radio terminal, and
the inter-terminal coordination information indicates a trust level of each resource in the first or second set.

### (Supplementary Note 11)

A program for causing a computer to perform a method for a first radio terminal, the method comprising:
performing sensing to detect resources reserved for sidelink transmission by one or more other radio terminals; and
transmitting, to the second radio terminal, inter-terminal coordination information generated based on a result of the sensing, wherein
the inter-terminal coordination information indicates a first set of preferred resources for sidelink transmission by the second radio terminal or a second set of non-preferred resources for sidelink transmission by the second radio terminal, and
the inter-terminal coordination information indicates a trust level of each resource in the first or second set.

### (Supplementary Note 12)

A second radio terminal comprising:
at least one radio transceiver; and
at least one processor coupled to the at least one radio transceiver and configured to receive, from a first radio terminal, inter-terminal coordination information generated based on a result of sensing by the first radio terminal, wherein
the inter-terminal coordination information indicates a first set of preferred resources for sidelink transmission by the second radio terminal or a second set of non-preferred resources for sidelink transmission by the second radio terminal, and
the inter-terminal coordination information indicates a trust level of each resource in the first or second set.

### (Supplementary Note 13)

The radio terminal according to Supplementary Note 12, wherein
the trust level of a first preferred or non-preferred resource, determined based on sidelink control information actually received from any other radio terminal during the sensing, is set to a first level, and
the trust level of a second preferred or non-preferred resource, determined based on hypothetical sidelink control information that could have been received in a slot that the first radio terminal was unable to monitor during the sensing, is set to a second level lower than the first level.

### (Supplementary Note 14)

The second radio terminal according to Supplementary Note 13, wherein the inter-terminal coordination information further indicates, with respect to the first preferred or non-preferred resource, a measurement result of Reference Signal Received Power (RSRP) of a transmission associated with the sidelink control information and a priority of sidelink transmission by the other radio terminal contained in the sidelink control information.

### (Supplementary Note 15)

The second radio terminal according to any one of Supplementary Notes 12 to 14, wherein the at least one processor is configured to perform resource selection for sidelink transmission by the second radio terminal, taking into account the inter-terminal coordination information.

### (Supplementary Note 16)

The second radio terminal according to any one of Supplementary Notes 12 to 15, wherein the at least one processor is configured to transmit a request for inter-terminal coordination to the first radio terminal.

### (Supplementary Note 17)

The second radio terminal according to Supplementary Note16, wherein the request includes information indicating a time interval for defining a plurality of candidate resources from which the first radio terminal selects the first or second set.

### (Supplementary Note 18)

The second radio terminal according to any one of Supplementary Notes 12 to 17, wherein
each resource is one or more sub-channels, and
each sub-channel contains a plurality of resource blocks in a single slot.

### (Supplementary Note 19)

A method performed by a second radio terminal, the method comprising:
receiving, from a first radio terminal, inter-terminal coordination information generated based on a result of sensing by the first radio terminal, wherein
the inter-terminal coordination information indicates a first set of preferred resources for sidelink transmission by the second radio terminal or a second set of non-preferred resources for sidelink transmission by the second radio terminal, and
the inter-terminal coordination information indicates a trust level of each resource in the first or second set.

### (Supplementary Note 20)

A program for causing a computer to perform a method for a second radio terminal, the method comprising:
receiving, from a first radio terminal, inter-terminal coordination information generated based on a result of sensing by the first radio terminal, wherein
the inter-terminal coordination information indicates a first set of preferred resources for sidelink transmission by the second radio terminal or a second set of non-preferred resources for sidelink transmission by the second radio terminal, and
the inter-terminal coordination information indicates a trust level of each resource in the first or second set.

### (Supplementary Note 21)

A first radio terminal comprising:
at least one radio transceiver; and
at least one processor coupled to the at least one radio transceiver and configured to:
   perform sensing to detect resources reserved for sidelink transmission by one or more other radio terminals;
   determine a first set of preferred resources for sidelink transmission by a second radio terminal or a second set of non-preferred resources for sidelink transmission by the second radio terminal, based on sidelink control information actually received from any other radio terminal during the sensing, without considering hypothetical sidelink control information that could have been received in a slot that the first radio terminal was unable to monitor during the sensing; and
   transmit, to the second radio terminal, inter-terminal coordination information indicating the first or second set.

### (Supplementary Note 22)

The first radio terminal according to Supplementary Note 21, wherein the inter-terminal coordination information further indicates, for each preferred or non-preferred resource, a measurement result of Reference Signal Received Power (RSRP) of a transmission associated with the sidelink control information and a priority of sidelink transmission by the other radio terminal contained in the sidelink control information.

### (Supplementary Note 23)

The first radio terminal according to Supplementary Note 21 or 22, wherein the inter-terminal coordination information is considered by the second radio terminal in resource selection for sidelink transmission by the second radio terminal.

### (Supplementary Note 24)

The first radio terminal according to any one of Supplementary Notes 21 to 23, wherein the at least one processor is configured to:
receive a request for inter-terminal coordination from the second radio terminal; and
transmit the inter-terminal coordination information to the second radio terminal in response to receiving the request.

### (Supplementary Note 25)

The first radio terminal according to Supplementary Note 24, wherein the request includes information indicating a time interval for defining a plurality of candidate resources from which the first radio terminal selects the first or second set.

### (Supplementary Note 26)

The first radio terminal according to any one of Supplementary Notes 1 to 6, wherein the at least one processor is configured to provide a Medium Access Control (MAC) layer, and a physical layer providing physical layer procedures, wherein
the MAC layer is configured to request the physical layer for a report of a subset of resources, and
the MAC layer is configured to indicate to the physical layer whether the report is for resource selection for sidelink transmission by the first radio terminal or for inter-terminal coordination.

### (Supplementary Note 27)

The first radio terminal according to Supplementary Note 26, wherein the physical layer is configured to:
if the request indicates that the report is for inter-terminal coordination, report the first or second set to the MAC layer; and
if the request indicates that the report is for resource selection for sidelink transmission by the first radio terminal, determine and report to the MAC layer a third set of candidate resources for sidelink transmission by the first radio terminal based on both the hypothetical sidelink control information and the actually received sidelink control information.

### (Supplementary Note 28)

The first radio terminal according to any one of Supplementary

Notes 21 to 27, wherein
each resource is one or more sub-channels, and
each sub-channel contains a plurality of resource blocks in a single slot.

### (Supplementary Note 29)

A method performed by a first radio terminal, the method comprising:
performing sensing to detect resources reserved for sidelink transmission by one or more other radio terminals;
determining a first set of preferred resources for sidelink transmission by a second radio terminal or a second set of non-preferred resources for sidelink transmission by the second radio terminal, based on sidelink control information actually received from any other radio terminal during the sensing, without considering hypothetical sidelink control information that could have been received in a slot that the first radio terminal was unable to monitor during the sensing; and
transmitting, to the second radio terminal, inter-terminal coordination information indicating the first or second set.

### (Supplementary Note 30)

A program for causing a computer to perform a method for a first radio terminal, the method comprising:
performing sensing to detect resources reserved for sidelink transmission by one or more other radio terminals;
determining a first set of preferred resources for sidelink transmission by a second radio terminal or a second set of non-preferred resources for sidelink transmission by the second radio terminal, based on sidelink control information actually received from any other radio terminal during the sensing, without considering hypothetical sidelink control information that could have been received in a slot that the first radio terminal was unable to monitor during the sensing; and
transmitting, to the second radio terminal, inter-terminal coordination information indicating the first or second set.

### (Supplementary Note 31)

A first radio terminal comprising:
at least one radio transceiver; and
at least one processor coupled to the at least one radio transceiver and configured to:
   perform sensing to detect resources reserved for sidelink transmission by one or more other radio terminals;
   determine existence of an expected or potential resource conflict at a resource indicated by sidelink control information of a second radio terminal, based on sidelink control information actually received from any other radio terminal during the sensing, without considering hypothetical sidelink control information that could have been received in a slot that the first radio terminal was unable to monitor during the sensing; and
   transmit, to the second radio terminal, inter-terminal coordination information indicating the existence of the resource conflict.

### (Supplementary Note 32)

The first radio terminal according to Supplementary Note 31, wherein the inter-terminal coordination information is considered by the second radio terminal to determine a resource to be reselected.

### (Supplementary Note 33)

A method performed by a first radio terminal, the method comprising:
performing sensing to detect resources reserved for sidelink transmission by one or more other radio terminals;
determining existence of an expected or potential resource conflict at a resource indicated by sidelink control information of a second radio terminal, based on sidelink control information actually received from any other radio terminal during the sensing, without considering hypothetical sidelink control information that could have been received in a slot that the first radio terminal was unable to monitor during the sensing; and
transmitting, to the second radio terminal, inter-terminal coordination information indicating the existence of the resource conflict.

### (Supplementary Note 34)

A program for causing a computer to perform a method for a first radio terminal, the method comprising:
performing sensing to detect resources reserved for sidelink transmission by one or more other radio terminals;
determining existence of an expected or potential resource conflict at a resource indicated by sidelink control information of a second radio terminal, based on sidelink control information actually received from any other radio terminal during the sensing, without considering hypothetical sidelink control information that could have been received in a slot that the first radio terminal was unable to monitor during the sensing; and
transmitting, to the second radio terminal, inter-terminal coordination information indicating the existence of the resource conflict.

This application is based upon and claims the benefit of priority from Japanese Patent Application No. 2021-125876, filed on Jul. 30, 2021, the disclosure of which is incorporated herein in its entirety by reference.

### REFERENCE SIGNS LIST

1 UE
2 RAN node
21 Cell
103 Inter-UE direct interface
1103 Baseband processor
1104 Application processor
1106 Memory
1107 Modules

What is claimed is:

1-34. (canceled)

35. A first radio terminal comprising:
at least one radio transceiver; and
at least one processor coupled to the at least one radio transceiver and configured to:
transmit inter-terminal coordination to a second radio terminal; and
receive, from the second radio terminal, information indicating a request for inter-terminal coordination, wherein
the inter-terminal coordination information includes a first set of preferred resources for sidelink transmission by the second radio terminal or a second set of non-preferred resources for sidelink transmission by the second radio terminal, and
the request includes information indicating a resource reservation interval for defining a plurality of candidate resources from which the first radio terminal selects the first set or the second set.

36. The first radio terminal according to claim 35, wherein
the inter-terminal coordination information indicates a trust level of each resource in the first or second set, and
the at least one processor is configured to:
perform sensing to detect resources reserved for sidelink transmission by one or more other radio terminals;
set, to a first level, the trust level of a first preferred or non-preferred resource determined based on sidelink control information actually received from another radio terminal during the sensing; and
set, to a second level lower than the first level, the trust level of a second preferred or non-preferred resource determined based on hypothetical sidelink control information that could have been received in a slot that the first radio terminal was unable to monitor during the sensing.

37. The first radio terminal according to claim 36, wherein the inter-terminal coordination information further indicates, with respect to the first preferred or non-preferred resource, a measurement result of Reference Signal Received Power (RSRP) of a transmission associated with the sidelink control information and a priority of sidelink transmission by the other radio terminal contained in the sidelink control information.

38. The first radio terminal according to claim 35, wherein the inter-terminal coordination information is considered by the second radio terminal in resource selection for sidelink transmission by the second radio terminal.

39. The first radio terminal according to claim 35, wherein the at least one processor is configured to transmit the inter-terminal coordination information to the second radio terminal in response to receiving the request.

40. The first radio terminal according to claim 35, wherein the at least one processor is configured to provide a Medium Access Control (MAC) layer, and a physical layer providing physical layer procedures, wherein
the MAC layer is configured to request the physical layer for a report of a subset of resources, and
the MAC layer is configured to indicate to the physical layer whether the report is for resource selection for sidelink transmission by the first radio terminal or for inter-terminal coordination.

41. A method performed by a first radio terminal, the method comprising:
transmitting inter-terminal coordination to a second radio terminal; and
receiving, from the second radio terminal, information indicating a request for inter-terminal coordination, wherein
the inter-terminal coordination information includes a first set of preferred resources for sidelink transmission by the second radio terminal or a second set of non-preferred resources for sidelink transmission by the second radio terminal, and
the request includes information indicating a resource reservation interval for defining a plurality of candidate resources from which the first radio terminal selects the first set or the second set.

42. The method according to claim 41, wherein
the inter-terminal coordination information indicates a trust level of each resource in the first or second set, and
the method further comprises:
performing sensing to detect resources reserved for sidelink transmission by one or more other radio terminals;
setting, to a first level, the trust level of a first preferred or non-preferred resource determined based on sidelink control information actually received from another radio terminal during the sensing; and
setting, to a second level lower than the first level, the trust level of a second preferred or non-preferred resource determined based on hypothetical sidelink control information that could have been received in a slot that the first radio terminal was unable to monitor during the sensing.

43. The method according to claim 42, wherein the inter-terminal coordination information further indicates, with respect to the first preferred or non-preferred resource, a measurement result of Reference Signal Received Power (RSRP) of a transmission associated with the sidelink control information and a priority of sidelink transmission by the other radio terminal contained in the sidelink control information.

44. The method according to claim 41, wherein the inter-terminal coordination information is considered by the second radio terminal in resource selection for sidelink transmission by the second radio terminal.

45. The method according to claim 41, wherein said transmitting comprises transmitting the inter-terminal coordination information to the second radio terminal in response to receiving the request.

46. The method according to claim 41, further comprising:
providing a Medium Access Control (MAC) layer, and a physical layer providing physical layer procedures;
requesting, by the MAC layer, the physical layer for a report of a subset of resources; and
indicating, by the MAC layer, to the physical layer whether the report is for resource selection for sidelink transmission by the first radio terminal or for inter-terminal coordination.

47. A non-transitory computer readable medium storing a program for causing a computer to perform a method for a first radio terminal, the method comprising:
transmitting inter-terminal coordination to a second radio terminal; and
receiving, from the second radio terminal, information indicating a request for inter-terminal coordination, wherein
the inter-terminal coordination information includes a first set of preferred resources for sidelink transmission by the second radio terminal or a second set of non-preferred resources for sidelink transmission by the second radio terminal, and
the request includes information indicating a resource reservation interval for defining a plurality of candidate resources from which the first radio terminal selects the first set or the second set.
